(19) United States
(12) Patent Application Publication
(10) Pub. No.: US 2016/0202052 A1
(43) Pub. Date: Jul. 14, 2016

(54) ULTRASONIC MEASUREMENT

(71) Applicant: THE LUBRIZOL CORPORATION, Wickliffe,, OH (US)

(72) Inventors: Oliver Smith, Chesterland, OH (US); Michael R. Sutton, Matlock (GB)

(21) Appl. No.: 14/916,716

(22) PCT Filed: Sep. 23, 2014
(86) PCT No.: PCT/US2014/056899

§ 371 Date: Mar. 4, 2016

Related U.S. Application Data
(60) Provisional application No. 61/884,247, filed on Sep. 30, 2013.

(51) Int. Cl. G01B 17/02; G01N 29/12; G01N 29/36; G01N 29/11

(52) U.S. Cl. CPC G01B 17/025; G01N 29/11; G01N 29/12; G01N 29/36

(57) ABSTRACT

Ultrasonic measurement apparatus 10 includes a transmitter 14 to transmit an ultrasonic signal 16 into an item 12. A receiver 18 receives echoes 20 from the item 12. The apparatus 10 measures the echo 20 and makes a comparison with another echo to extract information relating to a deposit of additional material at a surface of the item 12. For example, tribofilms or deposits may grow on the surface of the item 12 during use. A comparison of the echo, with previous echoes, allows the additional material to be detected and/or characterised.

The present invention relates to ultrasonic measurement.

In many circumstances, it is useful to be able to identify the appearance or growth of surface deposits or films, or to be able to characterise the nature of the deposit. Understanding these effects is particularly important in machine components such as vehicle engine components or bearings and can also be useful in testing the performance of an associated system, such as a lubrication system. For example these matters may affect performance. In other circumstances, it is useful to be able to obtain information about paint deposits or other coatings.

Examples of the present invention provide a method of ultrasonic measurement, the method comprising the steps of:

causing an ultrasonic signal to be transmitted into an item;

causing an echo of the transmitted ultrasonic signal to be received from the item;

measuring the echo; and

undertaking a comparison with another echo to extract information relating to additional material at a surface of the item.

The term “additional material” refers to material which forms as a deposit at the surface while the item is in use, or which is intentionally applied as a deposit to the surface, such as a paint or other coating. During use, the additional material may grow or may be removed by wear, erosion, chemical processes, or in other ways.

Echoes may be repeatedly measured for comparison as aforesaid to extract information relating to additional material. The frequency spectrum of the echo may be measured for comparison with another frequency spectrum. Information may be extracted by comparing the shapes of the frequency spectra. The comparison of shapes of the frequency spectra may be used to characterise the composition of the additional material. The frequency spectrum of an echo measured in the item in the absence of additional material may be subtracted from the frequency spectrum of an echo measured subsequently, to create a difference spectrum which is used to characterise the additional material. The difference spectrum may indicate the material of the additional material. The frequency spectrum of the echo may be obtained by an FFT analysis.

A measurement indicative of the energy returned in the echo may be made. The energy measurement may be used to indicate the thickness of the additional material. The energy measurement may be made by measuring the maximum amplitude of the echo. The energy measurement may be made by measuring the difference between the maximum and minimum values of the echo. The energy measurement may be made by an integration procedure. The integration may be applied to the echo in the time domain. The integration may be applied to a FFT of the echo.

The transmitted ultrasound signal may include a spectrum of frequencies. The said another echo may be an echo measured previously from the same item. The said another echo may be an echo derived by a mathematical model of the change. The mathematical model may be based on the geometry and material properties of the item and of the additional material at the surface.

The steps of transmitting and receiving may be repeated to measure a plurality of echoes, the plurality of echoes being combined for comparison with the said another echo.

The item may be a part having a surface within an engine.

The transmitted signal may include ultrasound at a frequency between 0.5 MHz and 100 MHz, such as 10 MHz.

Examples of the present invention also provide apparatus for ultrasonic measurement of an item, comprising:

a transmitter operable to transmit an ultrasonic signal into the item;

a receiver operable to receive from the item an echo of the transmitted signal; and

the apparatus being operable to measure the echo and to make a comparison with another echo to extract information relating to additional material at a surface of the item.

Echoes may be repeatedly measured for comparison as aforesaid to extract information relating to additional material. The frequency spectrum of the echo may be measured for comparison with another frequency spectrum. The apparatus may be operable to extract information by comparing the shapes of the frequency spectra. The comparison of shapes of the frequency spectra may be used to characterise the composition of the additional material. The frequency spectrum of an echo measured in the item in the absence of additional material may be subtracted from the frequency spectrum of an echo measured subsequently, to create a difference spectrum which is used to characterise the additional material. The difference spectrum may indicate the material of the additional material.

The transmitter may be operable to transmit an ultrasound signal which includes a spectrum of frequencies.

The apparatus may be operable to obtain the frequency spectrum of the echo by an FFT analysis.

A measurement indicative of the energy returned in the echo is made. The energy measurement may be used to indicate the thickness of the additional material. The energy measurement may be made by measuring the maximum amplitude of the echo. The energy measurement may be made by measuring the difference between the maximum and minimum values of the echo. The energy measurement may be made by an integration procedure. The integration may be applied to the echo in the time domain. The integration may be applied to a FFT of the echo.

The said another echo is an echo measured previously from the same item. The said another echo may be an echo derived by a mathematical model of the change.

The apparatus may be operable to repeat the steps of transmitting and receiving to measure a plurality of echoes, and further operable to combine the plurality of echoes comparison with the said another echo.

The item may be a part having a surface within an engine.

The transmitter may be operable to transmit a signal which includes ultrasound at a frequency between 0.5 MHz and 100 MHz, such as 10 MHz.

In another aspect, examples of the present invention provide software which, when installed on a computer system, is operable to perform the whole or any part of the method set out above.

Examples of the present invention will now be described in more detail, by way of example only, and with reference to the accompanying drawings, in which:

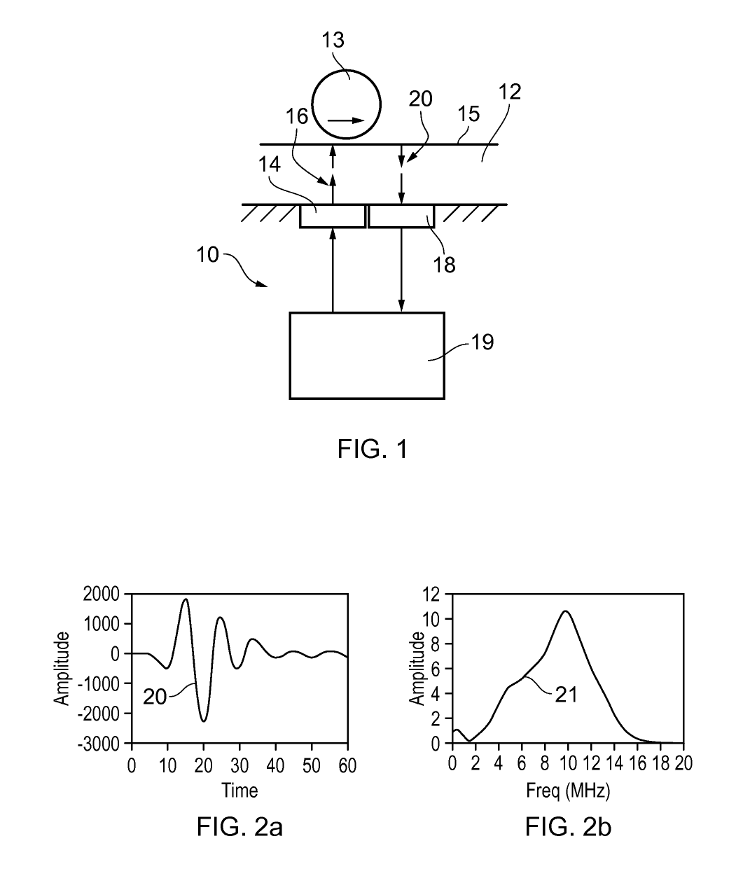

FIG. 1 is a simple schematic diagram of ultrasonic measurement apparatus in use to measure an item;

FIGS. 2(a) and (b) illustrate, respectively, an example echo signal received by the apparatus of FIG. 1 when used with a single layer material, and a Fast Fourier Transform (FFT) of the echo;

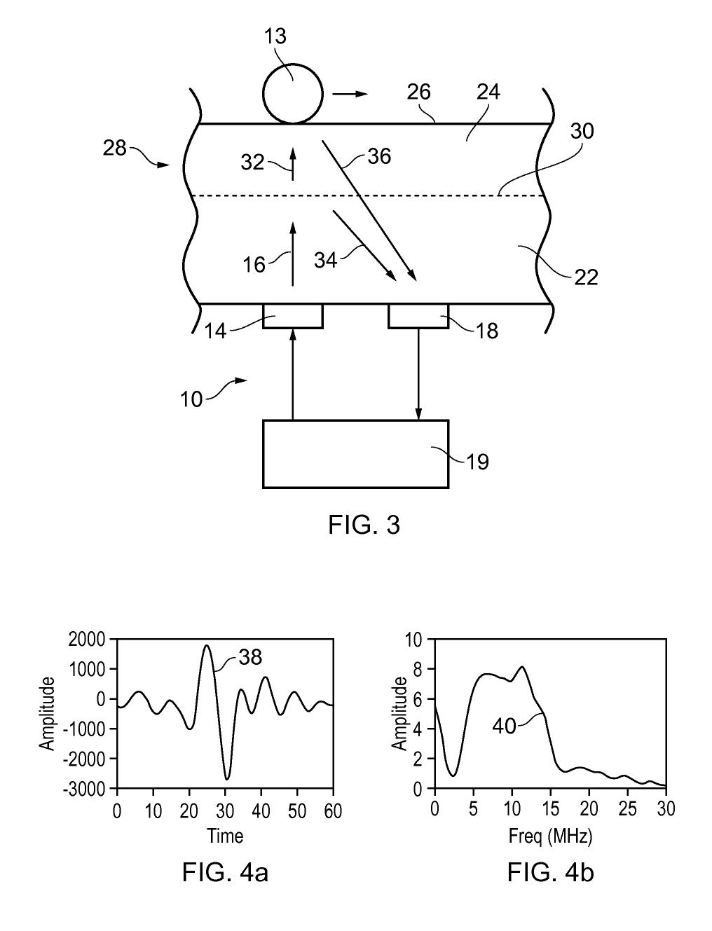

FIG. 3 is a partial and schematic section through a body and surface deposit layer, with associated ultrasonic measurement apparatus;

FIGS. 4(a) and (b) illustrate, respectively, an example echo signal received by the apparatus of FIG. 3, and an FFT of the echo;

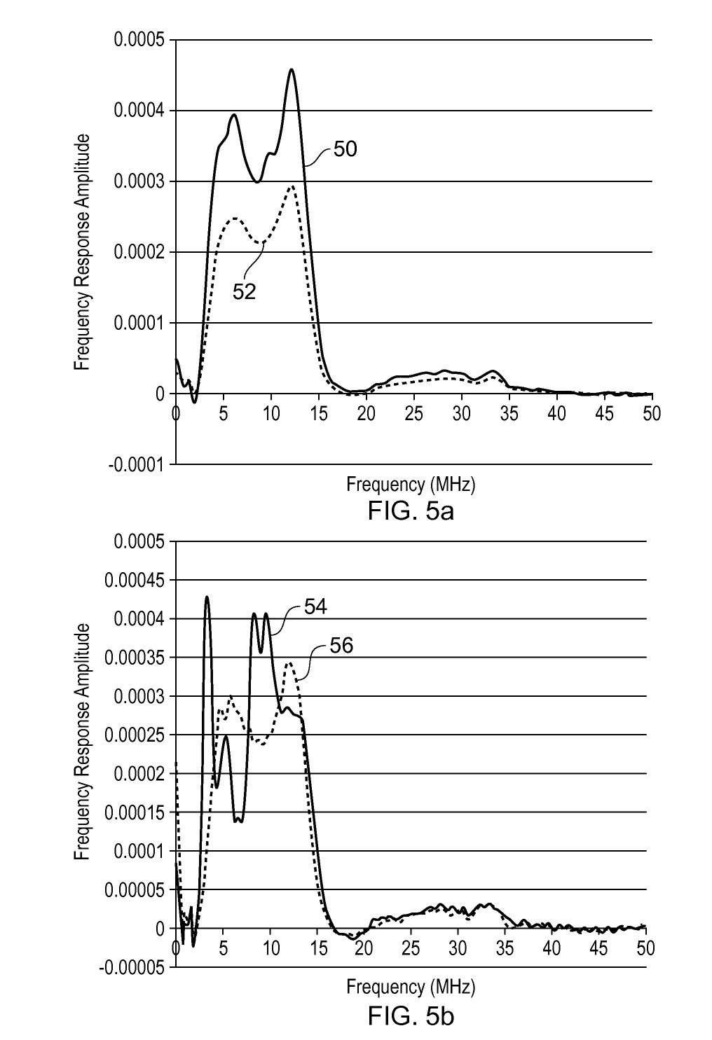

FIGS. 5a and 5b illustrate the frequency response obtained from the arrangement of FIG. 3, with different materials for the surface deposit layer; and

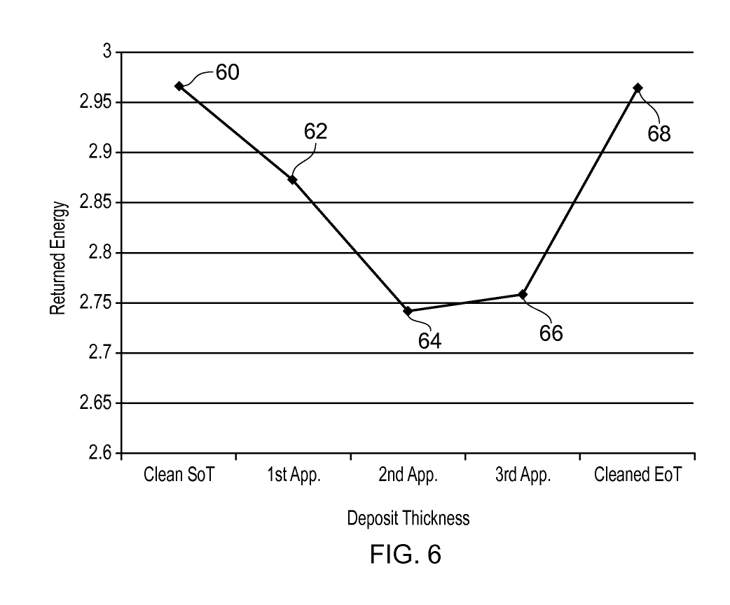

FIG. 6 illustrates energy measurements from an item having different thicknesses of surface deposit layer.

### OVERVIEW

FIG. 1 illustrates apparatus 10 for ultrasonic measurement of an item 12. The apparatus 10 comprises a transmitter 14 operable to transmit an ultrasonic signal (indicated at 16) into the item 12. A receiver 18 is operable to receive from the item 12 an echo (indicated at 20) of the transmitted signal 16. The apparatus 10 is operable to measure the echo 20, as will be described, and to make a comparison with another echo to extract information relating to a deposit of additional material at a surface 15 of the item 12.

In this example, the item 12 is a body of material which, in use, is associated with a second item 13, there being relative motion between the items 12, 13 during use. Examples include parts having a surface within an engine, such as power cylinder components, piston and cylinder liner assemblies, bearings etc. Changes may occur at the surface 15, during use, even if a second item 13 is not present. For example, chemical deposits (not shown) may grow on the surface 15, by adsorption or other processes. Hydrocarbon films may form as a result of coking within an engine. Engine oil may form hydrocarbon deposits and/or thermally derived films when encountering hot surfaces. Sliding or rolling contact between the items 12, 13, or other surface interactions may result in the growth of a tribofilm at the surface 15. Additional material may be present in the form of paint or other surface coating. This additional material may also be removed over time, by wear, erosion, chemical processes or in other ways.

The transmitter 14 and the receiver 18 are transducers of a type which can inject an ultrasonic signal into the item 12, and receive an echo. For example, the transducers 14, 18 may be piezo-ceramic transducers. In this example, the transducers 14, 18 are bonded to the item 12 in order to ensure a consistent interface between the transducers 14, 18 and the item 12, for reasons which will become apparent. Separate transducers 14, 18 are illustrated in the attached drawings, but it is envisaged that a single transceiver transducer could alternatively be used for both purposes.

The apparatus 10 also includes a data acquisition and processing unit 19. The unit 19 acquires data by generating signals applied to the transceiver 14 to inject an ultrasonic signal into the item 12, and by receiving signals detected by the transceiver 18, representing ultrasonic echoes created in response to the injected signal. The echo signals are processed by the unit 19 in order to extract information relating to a deposit of additional material at a surface 15 of the item 12, as will be described. In particular, FFT analysis is used in one example to measure the frequency spectra of echoes, and comparisons are made between spectra, to extract information relating to the item 12.

Many different technologies can be used to implement the unit 19. In one example, some or all of the processes which will be described are executed by a general purpose computing device operating under appropriate software control and communicating with the transducers 14, 18 by means of appropriate input and output interfaces (not illustrated separately). In another example, some or all of the processes are executed by dedicated devices. In other examples, a mixture of these approaches is used.

Operation with a Uniform Body

In order to understand the operation of the apparatus 10, it is appropriate first to describe this in relation to an item 12 which consists of a uniform body of a single material, as shown in FIG. 1. In this example, there is no deposit of additional material at the surface 15. In this example, the transmitter 14 is used to inject a short pulse of ultrasound (for example, a pulse of duration of 50 ns at 10 MHz). The shape and amplitude of the pulse should be reproducible, so that comparisons can be made, as will be described. This pulse of ultrasound forms the signal 16, which propagates across the item 12 as an ultrasonic pressure wave, eventually reflecting from the far side of the item 12, to create an echo 20. The echo 20 propagates back to the receiver 18. FIG. 2a illustrates a typical echo 20 received at the receiver 18 in these circumstances. The Fast Fourier Transform (FFT) of the echo 20 (FIG. 2b) is obtained by the unit 19 and shows that the echo 20 has a significant peak at the frequency (10 MHz) of the signal 16. In this simple example, a time of flight of the signal 16 and the echo 20 can be used to determine the thickness of the item 12.

### Operation in the Presence of Additional Material at a Surface

In many practical situations, the item of interest will not be a simple, uniform body of a single material. Examples include bearings with a working surface on which deposits or tribofilms may arise during use. In other examples, such as combustion chamber walls, various types of deposit may grow on the surface, or be removed. Surfaces may be coated during manufacture, by paints, wear protection layers, etc.

These scenarios are schematically illustrated in FIG. 3. A main body 22 has a surface layer 24 of additional material. The additional material 24 may grow during use by one of the processes mentioned above, such as chemical deposits, adsorption, coking or thermal deposits, or may be paint, wear protection or other surface coating. In use, the working surface 26 of the layer 24 may be exposed to sliding, rolling or other contact (or intermittent contact) with another component, or possibly erosion, corrosion or abrasion or the growth of deposits in various situations. The following examples seek to allow information to be extracted relating to the additional material 24 at the surface 30 of the item 22.

In this example the apparatus 10 is used to transmit a signal 16 into the main body 22. The signal 16 may again be a short pulse of 10 MHz ultrasound. The signal 16 will propagate through the main body 22 as a pressure wave, until meeting the boundary 30 between the main body 22 and the surface deposit layer 24. When the signal 16 encounters the boundary 30, some of the energy will propagate into the surface layer 24 as a signal 32; some of the energy will reflect from the boundary 30 as a first echo 34.

The signal 32 will propagate onward toward the outer surface 26. The first echo 34 will propagate back toward the receiver 18. When the signal 32 reaches the outer surface 26, it is reflected to create a second echo 36, which propagates back through the surface layer 24 and then through the main body 22, toward the receiver 18. The second echo (or additional echoes) may occur also, only or primarily within the layer 24, depending on the nature of interactions with the material of the layer 24. (It is to be noted that the indications of the signals and echoes in the drawings have been simplified in order to achieve clarity, particularly by ignoring the rules by which angles of incidence and reflection will be related in any practical situation. It is also to be noted that the strength of the echo 36 will be affected by the thickness of the surface layer 24, as discussed below).

When the second echo 36 reaches the receiver 18, the total path length traveled is longer than the total path length of the first echo 34 (which has traveled only to the boundary 30, before returning). Consequently, the second echo 36 is delayed in time, relative to the first echo 34. The two echoes 34, 36 form a wave superposition of the corresponding ultrasonic pressure waves and it is this superposition which is detected by the receiver 18 as an echo signal.

FIG. 4a illustrates a typical echo signal 38 received by the receiver 18 from a two layer system such as that illustrated in FIG. 3. In this example, the unit 19 detects the echo signal 38 and processes it by FFT analysis. It can be seen that the echo has a shape which is more complex than the echo received from a uniform body (FIG. 2a), as a result of the superposition of the two echoes 34, 36. Accordingly, the FFT 40 of the echo 38 (FIG. 4b) has a shape which is more complex than the FFT shown in FIG. 2b. The echo 38, and thus the shape of the FFT 40, both contain information about the layer 24, as can now be described, and can thus be used by the unit 19 to extract information relating to the additional material at the surface 30, as follows.

FIGS. 5a and 5b illustrate the results of an FFT analysis of echoes arising in the presence of deposit layers 24. In each case, a solid metal body 22 was fitted with a 10 MHz ultrasonic transducer 14 to create ultrasound signals 16 in the main body 22, as described above in relation to FIG. 3. Initially, a reference measurement was taken in the absence of any additional layer 24, so that only the first echo 34 is received at the receiver 18. A second measurement is then taken in the presence of a thick surface deposit layer 24 of titanium dioxide solution bonded to the surface 30 of the steel body 22. In this case, the echo received at the receiver 18 will include echoes from the surface 30 and from within the deposit layer 24 or at the surface of the layer 24. Echoes may be the result of reflection or of excitation of materials within the layer 24, or of absorption at a particular frequency or frequencies, or over one or more ranges of frequencies. A further measurement was taken after the titanium dioxide layer had been replaced with a thick deposit layer 24 of room temperature vulcanising silicone bonded to the steel body 22. Again, echoes are received by the receiver 18 from the boundary 30 and from within the deposit layer 24 or at the surface of the layer 24. This procedure was conducted at a data sampling rate (associated with the receiver 18) of 100 MHz and was repeated with a data sampling rate of 2 GHz. A 100 MHz data sampling rate was achieved by using real-time sampling. The 2 GHz data was collected using random interleave sampling.

Each of the echoes resulted in time-domain data from the receiver 18, similar to that illustrated in FIG. 4a. This time-domain data, relating to measurements taken in the absence of any deposit layer 24 and measurements taken in the presence of each of the deposit layers of titanium dioxide and silicone, was then processed using a Fast Fourier Transform technique. The data captured when no deposit layer 24 was present was then used as a reference spectrum by subtracting the reference spectrum from the frequency spectrum of the echo measured subsequently, in the presence of the titanium dioxide or silicone. This resulted in the plots shown in FIG. 5a and FIG. 5b, representing difference spectrums of deviations from the reference spectrum (no deposit layer) arising in the presence of two different materials constituting a deposit layer 24.

FIG. 5a represents the analysis at a data sampling rate of 100 MHz. FIG. 5b represents the results of the analysis at a data sampling rate of 2 GHz. In FIG. 5a, the higher trace 50 is derived from titanium dioxide. The lower trace 52 is derived from silicone. It can be seen from FIG. 5a that the presence of the layer of silicone has reduced the amplitude of the difference spectrum to a greater degree than the presence of the layer of titanium dioxide. It can also be seen there are differences in the frequency response between the two difference spectra. The most significant of these can be seen around the centre frequency of the transmitter 14 (in the region between about 5 MHz and 15 MHz, centred around the transmitter frequency of 10 MHz). The plot 50 from titanium dioxide is more complex in shape than the plot 52 from silicone, suggesting that the titanium dioxide deposit is interfering with the frequency response of the echo to a greater extent or in a more complex manner than the silicone is interfering. This is further confirmed by the results in FIG. 5b at a data sampling rate of 2 GHz, which reveal a trace 54 from titanium dioxide and 56 from silicone. The trace 54 is notably more complex in shape than the trace 56.

Various explanations could be made for these results. For example, they may be considered to illustrate different levels of absorption of certain frequencies by the titanium dioxide than by the silicone, and greater excitation of other frequencies. It is therefore envisaged that the difference spectra obtained as described above and illustrated in FIGS. 5a and 5b can be used to characterise the composition of the deposit layer 24. For example, FIGS. 5a and 5b illustrate how the presence of a layer of titanium dioxide can be distinguished from the presence of a layer of silicone.

It is envisaged that other effects may be occurring which will affect the spectrum measured from the echo but which can be expected to be constant for any particular set-up. For example, a higher sampling speed is expected to create better resolution of the data, as can be seen from FIGS. 5a and 5b. The frequency response of the transmitter 14 and receiver 18 is likely to affect the results achieved. For example, a receiver 18 with wider frequency response is likely to be able to identify characteristic spectra for a wider range of materials in the deposit layer 24. Thus, a very broad frequency response transducer measuring at a very high sampling rate may be expected to achieve better results than other alternatives. However, the depth of penetration of the ultrasound may reduce as frequency increases and this may also result in spectra being affected by non-uniformity of deposit.

Thus, the techniques described above are expected to create spectra which can represent a fingerprint for the characterisation of the deposit layer 24. The spectrum which is measured from an item can be compared with another spectrum, or a library of spectra, measured from the same item carrying different known surface deposit layers, or a spectrum or spectra modelled mathematically or otherwise.

### Operation in Relation to Deposit Growth or Removal

The arrangement illustrated in FIG. 3 can also be used in another manner, as follows:

An initial measurement is taken in the main body 22, in the absence of any deposit layer 24. The transmitter 14 is used to inject a short pulse of ultrasound (for example, a pulse of duration 50 ns at 10 MHz). An echo 34 propagates to the receiver 18, after reflection at the surface 30. The echo 34 is measured as will be described, to provide a measurement indicative of the energy returned in the echo 34. This provides a first data point 60 on a plot of results, shown in FIG. 6.

A deposit layer 24 is then applied to the surface 30. In this example, the deposit layer 24 is a layer of titanium dioxide applied in the presence of solvents and then allowed to dry. Once the deposit layer 24 is dry, a further signal 16 is sent from the transmitter 14 and the energy returned in the echo received at the receiver 18 is measured to provide a second data point 62 in FIG. 6. Two further data points 64, 66 are measured in the same way, after further increasing the thickness of the titanium dioxide layer in the manner described. Finally, the titanium dioxide was cleaned from surface 30 to allow a fifth data point 68 to be collected from an arrangement which corresponds with the arrangement of the first data point 60 and which can be seen to return substantially the same result.

A measurement indicative of the energy returned in the echo received at the receiver 18 can be achieved in various ways. In one simple example, the amplitude of the echo is recorded in the time domain. This allows the highest peak and the deepest trough (negative—going peak) to be identified. The difference between these measurements can be taken as a coarse measure of the energy in the echo pulse. The amplitude of the highest peak could alternatively be used in a similar manner.

In some circumstances, the energy in the echo pulse may be spread out in the time domain, so that the amplitude of the pulse does not strongly correlate with the energy of the pulse. Accordingly an energy measurement made by an integration procedure may be provided in order to take the measurement from the whole of the echo pulse. This integration may be performed in the time domain. Alternatively, the received echo may be processed in the frequency domain, for example by conducting a FFT analysis. Again, various data techniques can be applied to the FFT data, such as an integration technique to return a measurement indicative of the energy in the echo.

Each of these measurement techniques is found to return measurements which exhibit properties similar to those illustrated in FIG. 6. It can be seen in FIG. 6 that as the thickness of the layer of titanium dioxide increases from nothing (data point 60) to the first thickness (data point 62) and to the second thickness (data point 64), the energy returned to the receiver 18 from the boundary 30 reduces with increasing deposit thickness. This trend does not continue to the third thickness (data point 66), suggesting that the second thickness (data point 64) is at or beyond a threshold thickness for the titanium dioxide layer 24, beyond which the presence of additional deposit material 24 (the third thickness) does not influence the interaction at the boundary 30. Thus, the influence of the deposit layer 24 on the echo energy returned to the receiver 18 saturates at this thickness of deposit layer 24. Removing the deposit layer 24 to provide the data point 68 further suggests this conclusion.

The thickness of deposit layer 24 at which the process saturates is expected to be influenced by various factors, such as the frequency (or centre frequency) of the transmitter 14 and the bandwidth of the receiver 18. The response may also be non-linear with the energy of the transmitted signal 16. We envisage that a higher frequency signal 16 may carry less energy and therefore not penetrate as far into a deposit layer 24 and may thus saturate its response at a thinner deposit layer than would be the case with a lower frequency signal 16. We also envisage that the observed response (a reduction in energy with increased thickness, followed by a saturation) is likely to be true for longitudinal and also for shear waves. FIG. 6 represents measurements from longitudinal waves.

We have therefore shown that by measuring the echo in the manner described, to provide a data point of the type illustrated in FIG. 6, and undertaking a comparison with another echo (another data point from FIG. 6), information relating to the deposit layer 24 can be recovered. In this example, the information relates to the thickness of the layer 24. Some of the datapoints could be obtained by mathematical or other modelling techniques, to allow for comparisons with a measured datapoint.

The value of the data points 60 etc. are likely to be influenced by the identity of the material forming the deposit layer 24, as noted. Consequently, if the identity of the material is known, the example just described is expected to be able to provide a measurement of the thickness of the deposit layer 24. If the identity of the material is not known initially, we envisage that this technique could be combined with the previous example (FIG. 5 etc.) to allow the material of the deposit layer 24 to be identified, following which the echo energy measurements allow the thickness of the layer 24 to be measured.

This second example again shows how the comparison of the measured echo with another echo (which may be previously measured or previously modelled) can be used to extract information relating to additional material at a surface of the item.

### CONCLUDING COMMENTS

These examples illustrate that the techniques can be used to extract several different types of information about additional material at a surface of an item. In one example, the initial appearance or further growth of a surface layer can be identified, such as by the occurrence of a reduced echo energy (FIG. 6). In another example, the composition of a surface layer can be characterised, such as by the occurrence of a change of shape of the echo spectrum (FIGS. 5a and 5b).

Various examples of additional materials may grow as surface layers, surface deposits or films in a bearing or other structure, and are expected to be observable by the techniques set out above. These include, but are not limited to, those that form a tribofilm. “Tribofilm” is here intended to define chemistry that creates a film as a consequence of surface interactions such as sliding or rolling contact, and which is adhered on its parent worn surface but has different chemical composition, structure, and tribological behaviour. For example the tribofilm may include a layer formed from extreme pressure agents, antiwear agents, alkaline earth metal carbonate (typically calcium carbonate) typically from detergents, metal passivators, corrosion inhibitors, and friction modifiers. Of these the extreme pressure agents, antiwear agents and the calcium carbonate from detergents are believed to be the most common tribofilm forming chemistry. Extreme pressure agents typically deposit sulphur species such as sulphides on the surface, antiwear agents typically form polyphosphate or polythiophosphate films on the surface. The polyphosphate or polythiophosphate films tend to form from zinc dialkyldithiophosphates, and sulphides from sulphurised olefins.

Other examples include hydrocarbon deposits, hydrocarbon based deposits and other deposits which form during use, as a result of various processes. Processes may include chemical processes, thermal reactions, oxidation, wear, erosion etc.

In any of the examples described above, the measured echo for comparison with another echo can be derived as a single (instantaneous) measurement. However, it may be advantageous to make repeated measurements (perhaps a large number, such as 200) to measure a plurality of echoes, so that these plurality of echoes can be combined for comparison purposes. This allows some averaging or other statistical analysis to be used to improve the data obtained. It is expected that a large number of repeated measurements can be taken very quickly in comparison with the rate at which deposits will grow at the surface, in any practical situation.

We envisage that the techniques described above can be used in practice to provide real-time characterisation and thickness measurement of deposits (including applied coatings and those which arise during use) in machines, during normal use, allowing improved monitoring, maintenance scheduling and reliability. We envisage that these techniques will be successful across a range of temperatures. We envisage that, in some circumstances, the echoes which are compared should each have been measured at or modelled for substantially the same temperature within the items being measured. Temperature calibration prior to testing is also desirable. In other circumstances, the mechanisms which give rise to echoes, particularly within the layer 24, may be independent of, or less dependent on temperature.

We envisage that these techniques will allow detection at a resolution which depends on the ultrasound frequency used.

The techniques make comparisons between measurements made at different times and it is therefore important that the arrangement of the measurement apparatus and the workpiece remains consistent throughout or can be calibrated with adequate accuracy. In particular, we envisage it will be particularly advantageous to use a transducer which is bonded to the workpiece, as described above, for consistency of data.

Many variations and modifications can be made without departing from the scope of the present invention. An ultrasound frequency of 10 MHz has been described; other frequencies could be used. Other arrangements could be used for injecting ultrasound into a workpiece, detecting echoes and measuring and comparing them.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of ultrasonic measurement, the method comprising the steps of:
causing an ultrasonic signal to be transmitted into an item;
causing an echo of the transmitted ultrasonic signal to be received from the item;
measuring the echo; and
undertaking a comparison with another echo to extract information relating to additional material at a surface of the item.

2. A method according to claim 1, wherein echoes are repeatedly measured for comparison as aforesaid to extract information relating to additional material.

3. A method according to claim 1 or 2, wherein the frequency spectrum of the echo is measured for comparison with another frequency spectrum.

4. A method according to claim 3, wherein information is extracted by comparing the shapes of the frequency spectra.

5. A method according to claim 4, wherein the comparison of shapes of the frequency spectra is used to characterise the composition of the additional material.

6. A method according to claim 4 or 5, wherein the frequency spectrum of an echo measured in the item in the absence of additional material is subtracted from the frequency spectrum of an echo measured subsequently, to create a difference spectrum which is used to characterise the additional material.

7. A method according to claim 6, wherein the difference spectrum indicates the material of the additional material.

8. A method according to any of claims 1 to 7, wherein the frequency spectrum of the echo is obtained by an FFT analysis.

9. A method according to any of claims 1 to 8, wherein a measurement indicative of the energy returned in the echo is made.

10. A method according to claim 9, wherein the energy measurement is used to indicate the thickness of the additional material.

11. A method according to claim 9 or 10, wherein the energy measurement is made by measuring the maximum amplitude of the echo.

12. A method according to claim 9, 10 or 11, wherein the energy measurement is made by measuring the difference between the maximum and minimum values of the echo.

13. A method according to claim 9 or 10, wherein the energy measurement is made by an integration procedure.

14. A method according to claim 13, wherein the integration is applied to the echo in the time domain.

15. A method according to claim 14, wherein the integration is applied to a FFT of the echo.

16. A method according to any preceding claim, wherein the transmitted ultrasound signal includes a spectrum of frequencies.

17. A method according to any preceding claim, wherein the said another echo is an echo measured previously from the same item.

18. A method according to any of claims 1 to 16, wherein the said another echo is an echo derived by a mathematical model of the change.

19. A method according to claim 17, wherein the mathematical model is based on the geometry and material properties of the item and of the additional material at the surface.

20. A method according to any preceding claim, wherein the steps of transmitting and receiving are repeated to measure a plurality of echoes, the plurality of echoes being combined for comparison with the said another echo.

21. A method according to any preceding claim, wherein the item is a part having a surface within an engine.

22. A method according to any preceding claim, where the transmitted signal includes ultrasound at a frequency between 0.5 MHz and 100 MHz, such as 10 MHz.

23. Apparatus for ultrasonic measurement of an item, comprising:
a transmitter operable to transmit an ultrasonic signal into the item;
a receiver operable to receive from the item an echo of the transmitted signal; and
the apparatus being operable to measure the echo and to make a comparison with another echo to extract information relating to additional material at a surface of the item.

24. Apparatus according to claim 23, wherein echoes are repeatedly measured for comparison as aforesaid to extract information relating to additional material.

25. Apparatus according to claim 22 or 24, wherein the frequency spectrum of the echo is measured for comparison with another frequency spectrum.

26. Apparatus according to claim 25, wherein the apparatus is operable to extract information by comparing the shapes of the frequency spectra.

27. Apparatus according to claim 26, wherein the comparison of shapes of the frequency spectra is used to characterise the composition of the additional material.

28. Apparatus according to claim 26 or 27, wherein the frequency spectrum of an echo measured in the item in the absence of additional material is subtracted from the frequency spectrum of an echo measured subsequently, to create a difference spectrum which is used to characterise the additional material.

29. Apparatus according to claim 28, wherein the difference spectrum indicates the material of the additional material.

30. Apparatus according to any of claims 23 to 29, wherein the transmitter is operable to transmit an ultrasound signal which includes a spectrum of frequencies.

31. Apparatus according to any of claims 23 to 30, operable to obtain the frequency spectrum of the echo by an FFT analysis.

32. Apparatus according to any of claims 23 to 31, wherein a measurement indicative of the energy returned in the echo is made.

33. Apparatus according to claim 32, wherein the energy measurement is used to indicate the thickness of the additional material.

34. Apparatus according to claim 32 or 33, wherein the energy measurement is made by measuring the maximum amplitude of the echo.

35. Apparatus according to claim 32, 33 or 34, wherein the energy measurement is made by measuring the difference between the maximum and minimum values of the echo.

36. Apparatus according to claim 32 or 33, wherein the energy measurement is made by an integration procedure.

37. Apparatus according to claim 36, wherein the integration is applied to the echo in the time domain.

38. Apparatus according to claim 37, wherein the integration is applied to a FFT of the echo.

39. Apparatus according to any of claims 23 to 38, wherein the said another echo is an echo measured previously from the same item.

40. Apparatus according to any of claims 23 to 38, wherein the said another echo is an echo derived by a mathematical model of the change.

41. Apparatus according to any of claims 23 to 40, operable to repeat the steps of transmitting and receiving to measure a plurality of echoes, and further operable to combine the plurality of echoes comparison with the said another echo.

42. Apparatus according to any of claims 23 to 41, wherein the item is a part having a surface within an engine.

43. Apparatus according to any of claims 23 to 42, where the transmitter is operable to transmit a signal which includes ultrasound at a frequency between 0.5 MHz and 100 MHz, such as 10 MHz.

44. Software which, when installed on a computer system, is operable to perform the whole or any part of the method of any claims 1 to 22.

45. A method of ultrasonic measurement, substantially as described above, with reference to the accompanying drawings.

46. Apparatus for ultrasonic measurement of an item, substantially as described above, with reference to the accompanying drawings.
